(19) United States
(12) Patent Application Publication
(10) Pub. No.: US 2017/0373460 A1
(43) Pub. Date: Dec. 28, 2017

(54) LASER-DRIVEN LIGHT SOURCE DEVICE

(71) Applicant: USHIO DENKI KABUSHIKI KAISHA, Tokyo (JP)

(72) Inventor: Toshio YOKOTA, Tokyo (JP)

(73) Assignee: USHIO DENKI KABUSHIKI KAISHA, Tokyo (JP)

(21) Appl. No.: 15/625,693

(22) Filed: Jun. 16, 2017

(30) Foreign Application Priority Data
Jun. 23, 2016 (JP) 2016-124148

(51) Int. Cl. H01S 3/091; H01S 3/094; H01S 3/0941; H05G 2/00

(52) U.S. Cl. CPC H01S 3/0912; H05G 2/008; H01S 3/094076; H01S 3/0941

(57) ABSTRACT

A light source device includes a laser oscillator for emitting a continuous laser beam and a pulsed laser beam. The laser oscillator has a resonator, at least one laser medium in the resonator, a first pumping unit for supplying light to the laser medium, and a second pumping unit for supplying another light to the laser medium. The light source device also includes a plasma vessel to receive the continuous laser beam and the pulsed laser beam from the laser oscillator, generate plasma, and emit light derived from the plasma. The light source device also includes a first electricity feeder for feeding electricity to the first pumping unit, a second electricity feeder for feeding electricity to the second pumping unit, and a controller for controlling the first and second electricity feeders such that the first pumping unit generates continuous light, and the second pumping unit generates pulsed light.

### FIELD OF THE INVENTION

The present invention relates to a laser-driven light source device, and particularly a laser-driven light source device that emits and converges (condenses) a pulsed laser beam and a continuous laser beam in a plasma vessel to generate plasma.

### DESCRIPTION OF THE RELATED ART

A light source device that directs laser beam, which is emitted from a laser oscillator, to a plasma vessel, which contains a light emitting gas sealed therein, to excite the light emitting gas and emit light is disclosed in, for example, Japanese Patent Application Laid-open Publications No. Sho 61-193358.

FIG. 12 of the accompanying drawings shows a structure of the light source device of Japanese Patent Application Laid-open Publications No. Sho 61-193358. Specifically, a laser-driven light source device 200 includes a laser oscillator 210, a concave lens 220 to expand the laser beam, which is received from the laser oscillator 210, a convex lens 230 to change the expanded laser beam, which is received from the concave lens 220, into parallel light, another convex lens 240 to converge the parallel laser beam, a plasma vessel 250 to which the converged laser beam is incident, and a concave mirror 260 to reflect and converge the laser beam, which has passed through the plasma vessel 250.

A light emitting chemical element is sealed in the plasma vessel 250. As the converged laser light is introduced into the plasma vessel 250, the light emitting chemical element is excited and the plasma is generated. Thus, excitation light is obtained.

Japanese Patent Application Laid-Open Publication No. Sho 61-193358, page 2, upper right column, lines 16-18 indicate that the laser oscillator oscillates the continuous or pulsed laser beam that has sufficient intensity to cause discharge and excitation of the gas sealed in the plasma vessel.

### SUMMARY OF THE INVENTION

The laser beam used to excite the light emitting gas, which is sealed in the plasma vessel, in the above-described light source device may be a continuous laser beam or a pulsed laser beam, which is disclosed in Japanese Patent Application Laid-Open Publication No. Sho 61-193358. However, the continuous laser beam and the pulsed laser beam have the following problems.

In case of the pulsed laser beam, oscillated is the pulsed laser beam that has sufficient intensity to discharge and excite the light emitting gas. Thus, the lighting starts. However, because the laser beam is intermittently incident to the sealed gas, the state of high temperature plasma may become intermittent when the laser beam is intermittent. In other words, it is difficult to always maintain the state of high temperature plasma. Thus, the discharge state is unstable.

In case of the continuous laser beam, the lighting starts as the continuous laser beam that has a sufficient intensity to trigger the discharge of the light emitting gas is oscillated. However, if the same energy as the energy supplied at the start of the lighting is supplied to the plasma vessel to keep the state of high temperature plasma, the plasma vessel is heated, and the resulting heat may deform and break a bulb. Thus, the life of the lighting is short.

The power of the laser beam, which is necessary to start the discharge, is between several tens kW and several hundreds kW. The laser device configured to continuously generate the laser beam at such high output has a large size and is expensive. Thus, use of such laser device is not practical.

The present invention is proposed to overcome the above-described problems. One object of the present invention is to provide a laser-driven light source device that does not need to emit a laser beam at a high power, but can stably maintain the high temperature plasma state after the start of the lighting, i.e., can stably maintain the lighting. Another object of the present invention is to provide a laser-driven light source device that can suppress the reduction in the lighting life due to heating of a plasma vessel of the light source device. The laser beam is introduced to the plasma vessel from a laser oscillator of the light source device.

According to one aspect of the present invention, there is provided a laser-driven light source device that includes a laser oscillator configured to emit a continuous laser beam and a pulsed laser beam. The laser oscillator has a resonator in which a pair of reflection mirrors are disposed, at least one laser medium placed in the resonator, a first pumping unit configured to supply light to the laser medium (or media), and a second pumping unit configured to supply another light to the laser medium (or media). The laser-driven light source device also includes a plasma vessel configured to receive the continuous laser beam and the pulsed laser beam from the laser oscillator, generate plasma, and emit light derived from the plasma. The laser-driven light source device also includes a first electricity feeding unit configured to feed electricity to the first pumping unit, a second electricity feeding unit configured to feed electricity to the second pumping unit, and a controller configured to control the first electricity feeding unit such that the first pumping unit generates continuous light, and control the second electricity feeding unit such that the second pumping unit generates pulsed light.

The controller may control the first and second electricity feeding units such that the pulsed laser beam generates the plasma in the plasma vessel, the continuous laser beam maintains the plasma (the continuous laser beam stabilizes the plasma), and then the pulsed laser beam is halted.

The “at least one laser medium” may be a single laser medium, and the first and second pumping units may face the single laser medium.

The “at least one laser medium” may include a first laser medium and a second laser medium. The first and second laser media may be arranged in series such that a center axis of the first laser medium aligns with a center axis of the second laser medium. The first pumping unit may face the first laser medium, and the second pumping unit may face the second laser medium.

The laser-driven light source device may further include a partially transmissive mirror placed on an optical path between the laser oscillator and the plasma vessel. The partially transmissive mirror may be configured to extract part of the pulsed laser beam and the continuous laser beam emitted from the laser oscillator. The laser-driven light source device may further include a laser beam monitor configured to receive the extracted laser beam.

The laser-driven light source device may further include an optical sensor disposed outside the plasma vessel and configured to receive excitation light emitted from the plasma vessel. The controller may determine whether the plasma is maintained (becomes stable) in the plasma vessel based on the excitation light received at the optical sensor, and may control the second electricity feeding unit such that the pulsed laser is halted when the controller confirms that the plasma is in a stable condition.

In the light source device according to one aspect of the present invention, at least two pumping units are provided for the laser medium (or media), and the pumping units independently supply the pulsed light and the continuous light to the laser medium (or media). Therefore, when the pulsed laser beam and the continuous laser beam are directed to the plasma vessel, it is possible to create a high temperature plasma state with the pulsed laser beam, stabilize and maintain the high temperature plasma state with the continuous laser beam, and stop the pulsed laser beam after the high temperature plasma state becomes stable. Accordingly, the high temperature plasma state does not discontinue, and the stable discharge state is obtained.

The required intensity of the continuous laser beam is an intensity that can stabilize and/or maintain the high temperature plasma state. Thus, the plasma vessel is not heated very much by the continuous laser beam, and can have a long life. Because the peak power of the pulsed laser beam is high, it is possible to create the high temperature plasma state by the laser oscillator even if the average output of the laser oscillator is relatively low. Because the continuous laser beam is emitted from the laser oscillator that has a relatively small output, the size of the light source device does not become large.

Because the laser oscillator includes the resonator, the laser medium (or media) placed in the resonator, and at least two pumping units configured to supply light to the laser medium (or media), the light source device does not have to use two laser units, but is still able to irradiate the plasma vessel with the pulsed laser beam and the continuous laser beam. Accordingly, the light source device can have a simple structure.

Because the pulsed laser beam and the continuous laser beam are emitted from the single laser oscillator, which includes the resonator with a pair of reflection mirrors, the optical path of the pulsed laser beam overlaps the optical path of the continuous laser beam. In the plasma vessel, therefore, the high energy area of the pulsed laser beam can be superposed on the high energy area of the continuous laser beam in a reliable manner. Consequently, the generation of the high temperature plasma state and the stabilization (maintaining) of the high temperature plasma state are carried out in a reliable manner. Thus, it is possible to avoid the discontinuing of the high temperature plasma state, and provide stable discharging.

If a partially reflective mirror is placed on an optical path between the laser oscillator and the plasma vessel, and a laser beam monitor is provided to receive the light reflected by the partially reflective mirror, then it is possible to determine or confirm the irradiation condition of the laser beam. If the electricity to be fed to the pumping unit from the electricity feeding unit is controlled on the basis of the output of the laser beam monitor, it is possible to control the intensity of the laser beam.

If an optical sensor is disposed outside (near) the plasma vessel to receive the excitation light, which is generated in the plasma vessel and is emitted from the plasma vessel, it is possible to determine or confirm the lighting condition of the plasma vessel.

These and other objects, aspects and advantages of the present invention will become apparent to those skilled in the art from the following detailed description when read and understood in conjunction with the appended claims and drawings.

### BRIEF DESCRIPTION OF THE DRAWINGS

FIG. 1 shows a configuration of a laser-driven light source device according to a first embodiment of the present invention.

FIG. 2 shows a configuration of a laser oscillator of the light source device shown in FIG. 1.

FIG. 3A shows a timing chart of a first electricity feeding device of the light source device shown in FIG. 1.

FIG. 3B shows a timing chart of a second electricity feeding device.

FIG. 3C shows an intensity of a laser beam emitted from the laser oscillator.

FIG. 3D shows plasma generated in a plasma vessel.

FIG. 4A shows another timing chart of the first electricity feeding device of the light source device shown in FIG. 1 in a different example.

FIG. 4B shows another timing chart of the second electricity feeding device.

FIG. 4C shows an intensity of the laser beam emitted from the laser oscillator.

FIG. 4D shows plasma generated in the plasma vessel.

FIG. 5 shows another exemplary laser oscillator according to the present invention.

FIG. 6 shows a configuration of a laser-driven light source device according to a second embodiment of the present invention.

FIG. 7 shows a configuration of a laser-driven light source device according to a modification to the second embodiment of the present invention.

FIG. 8 shows a configuration of a laser-driven light source device according to a third embodiment of the present invention.

FIG. 9 shows a configuration of a laser-driven light source device according to a fourth embodiment of the present invention.

FIG. 10 shows a configuration of a laser-driven light source device according to a fifth embodiment of the present invention.

FIG. 11 shows a configuration of a laser-driven light source device according to a sixth embodiment of the present invention.

FIG. 12 shows a configuration of a conventional laser-driven light source device.

### DETAILED DESCRIPTION OF THE INVENTION

### First Embodiment

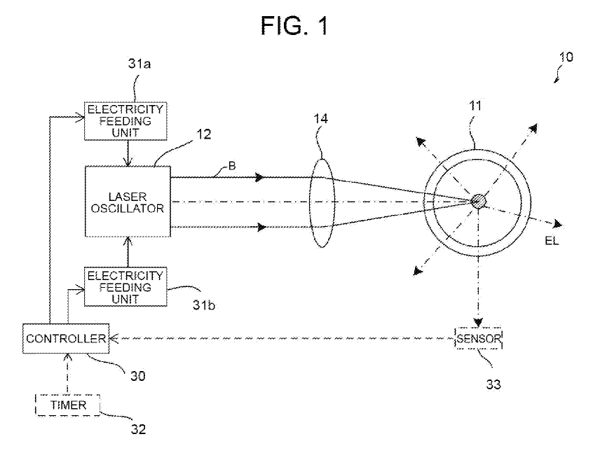

FIG. 1 illustrates a schematic view of a laser-driven light source device 10 according to a first embodiment of the present invention. A plasma vessel 11 is shown in a cross-sectional view.

The laser-driven light source device 10 shown in FIG. 1 includes a laser oscillator 12 to emit a laser beam B, the plasma vessel 11 to which the laser beam B is incident, a first electricity feeding unit 31a to feed electricity to the laser oscillator 12, a second electricity feeding unit 31a to feed electricity to the laser oscillator 12, and a controller 30 to control the electricity feeding units 31a and 31b.

One or more light emitting chemical elements are contained and sealed in the plasma vessel 11. Various light emitting chemical elements may be contained in the plasma vessel 11 depending upon use of the chemical element(s) or use of the light source device 10. For example, a mixture of mercury and xenon gas or a mixture of mercury and an argon gas may be contained in the plasma vessel 11 as the light emitting chemical elements, if the light source device 10 is used for exposure. Alternatively, a xenon gas may be contained in the plasma vessel 11 as the light emitting chemical element, if the light source device 10 is used for a motion picture projector.

The plasma vessel 11 receives the laser beam B from the laser oscillator 12, and emits excitation light EL, which is generated from the light emitting element(s). Thus, the plasma vessel 11 is made from materials and members that allow the laser beam B emitted from the laser oscillator 12 to pass therethrough, and that allow the excitation light EL emitted from the light emitting element(s) to pass therethrough. Specifically, when the wavelength of the laser beam from the laser oscillator 12 is 1064 nm, the light emitting chemical element is mercury, and the 356 nm wavelength of the excitation light from mercury is used, then the plasma vessel 11 is made from, for example, quartz glass (silica glass) that allows the 1064 nm wavelength to pass therethrough and the 365 nm wavelength to pass therethrough.

A light converging (condensing) unit 14 is provided between the laser oscillator 12 and the plasma vessel 11, and is present on an optical path of the laser beam B emitted from the laser oscillator 12. The light converging unit 14 may include a converging lens or a DOE (Diffractive Optical Element), which has a light converging function. The focal point of the light converging unit 14 is present inside the plasma vessel 11. It should be noted that although the light converging unit 14 of FIG. 1 is the light converging lens that transmits the laser beam B, the light converging element 14 may be any suitable component that has a light converging function, such as a light converging elliptical mirror or a light converging parabolic mirror, which reflects and converges the laser beam B.

When the light converging unit 14 is disposed in the vicinity of the plasma vessel 11, the light converging unit 14 may be irradiated with the excitation light EL emitted from the plasma vessel 11. If the light converging unit 14 was made from a material that did not transmit the excitation light, then the light converging unit 14 would absorb the excitation light, generate heat, and break. In order to avoid this, it is preferred that the light converging unit 14 is made from a material that transmits the excitation light emitted from the plasma vessel 11. In other words, it is preferred that the light converging unit 14 is made from the same material as the material of the plasma vessel 11, or made from a material that reflects the excitation light emitted from the plasma vessel 11.

It should be noted that as indicated by the broken line in FIG. 1, a timer circuit 32 is provided and connected to the controller 30. Also, an optical sensor 33 is provided outside the plasma vessel 11 to receive the excitation light EL from the plasma vessel 11. The timer circuit 32 and the optical sensor 33 will be described later.

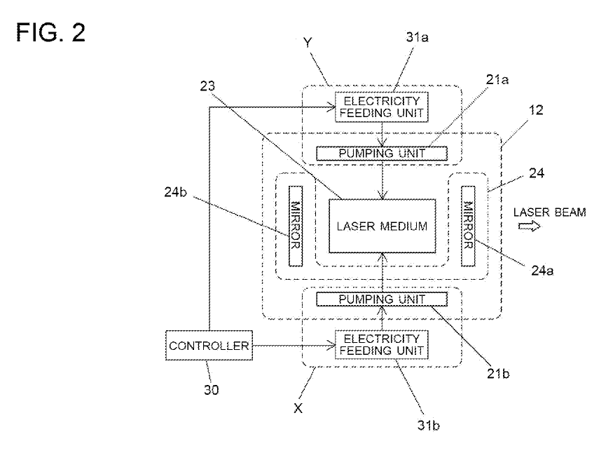

Referring now to FIG. 2, the laser oscillator 12 of the laser-driven light source device 10 will be described.

FIG. 2 schematically illustrates the configuration of the laser oscillator 12.

The laser oscillator 12 has an resonator 24, a laser medium 23 placed in the resonator 24, and a pair of pumping units 21a and 21b to supply light to the laser medium 23.

The pumping units 21a and 21b are connected to the electricity feeding units 31a and 31b, respectively. The electricity feeding units 31a and 31b are connected to the controller 30.

The resonator 24 has a pair of reflection mirrors 24a and 24b. The first reflection mirror 24a is a partial reflection mirror, and the second reflection mirror 24b is a total reflection mirror.

The single laser medium 23 is disposed on an optical path in the resonator 24.

The laser medium 23 may be a laser medium that is used for a stationary laser, such as Nd:YAG crystal, Yb:YAG crystal, or Nd:glass.

The first pumping unit 21a and the second pumping unit 21b are disposed outside the laser medium 23 such that the first pumping unit 21a and the second pumping unit 21b supplies the light to the laser medium 23.

Each of the pumping units is configured to supply the light that excites the laser medium 23. For the example, each pumping unit may include a lamp or a plurality of laser diodes (LD).

The first pumping unit 21a and the second pumping unit 21b are connected to the electricity feeding units 31a and 31b, respectively. Specifically, the first electricity feeding unit 31a that continuously feeds an electric current (or feeds a continuous electric current) is connected to the first pumping unit 21a, and the second electricity feeding unit 31b that feeds a pulsed electric current is connected to the second pumping unit 21b.

The electricity to be fed to the first and second pumping units 21a and 21b from the first and second electricity feeding units 31a and 31b is controlled by the controller 30 that is connected to the first and second electricity feeding units 31a and 31b.

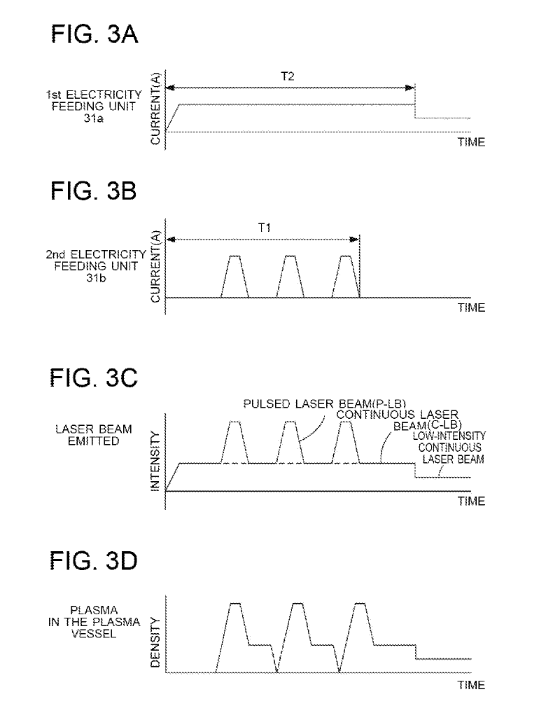

FIG. 3A to FIG. 3D are timing charts to show one mode of operation after the laser oscillator 12 of the light source device 10 is activated.

The operations of the laser-driven light source device 10 and the laser oscillator 12 will be described with reference to FIG. 1 to FIG. 3D.

As shown in FIG. 3A, the controller 30 controls the first electricity feeding unit 31a to continuously supply the electric current to the first pumping unit 21a. Thus, the first pumping unit 21a continuously supplies the light (supplies continuous light) to the laser medium 23.

As shown in FIG. 3B, the controller 30 controls the second electricity feeding unit 31b to supply the pulsed electric current to the second pumping unit 21b after the first electricity feeding unit 31a starts the supply of the continuous electric current, which has a predetermined current value, to the first pumping unit 21a. Thus, the second pumping unit 21b supplies the pulsed light to the laser medium 23.

As the laser medium 23 receives the light from the first pumping unit 21a and the light from the second pumping unit 21b, the laser medium 23 is excited by the light. As a result, as shown in FIG. 3C, the laser medium 23 is excited on the basis of a cumulative value of the intensity of the light from the first pumping unit 21a and the intensity of the light from the second pumping unit 21b. Therefore, the laser beam generated from the laser medium 23 is the superposition of the laser beam that corresponds to the continuous light from the first pumping unit 21a (C-LB) and the laser beam that corresponds to the pulsed light from the second pumping unit 21b (P-LB).

Consequently, the laser beam B is the continuous laser beam and also contains a pulsing portion that has an intermittently increasing light intensity.

The laser beam B emitted from the laser oscillator 12 is converged by the converging element 14, which is shown in FIG. 1, such that it makes a focal point inside the plasma vessel 11. Thus, the light emitting chemical elements are excited in the plasma vessel 11, and the high temperature plasma state is established, as shown in FIG. 3D. The excitation light is generated from the light emitting chemical elements in the high temperature plasma state. The plasma vessel 11 is hermetically sealed.

The light emitting chemical elements sealedly located in the plasma vessel 11 need a large energy to create (establish) the high temperature plasma state. The intensity of the pulsing portion of the laser beam is able to create the high energy although it is intermittent. Therefore, the inventor assumes that the light emitting chemical elements become the high temperature plasma state with such pulsing portion of the laser beam (P-LB).

After the high temperature plasma state is established, an energy needed to maintain this high temperature plasma state is smaller than the energy needed to establish the high temperature plasma state, and should be supplied continuously.

The laser beam emitted after the establishing of the high temperature plasma state is the continuous laser beam C-LB, as shown in FIG. 3D. Thus, it is possible to maintain the high temperature plasma state.

As such, the pulsing portion of the laser beam is not necessary after the high temperature plasma state is stabilized and maintained. To keep the pulsing portion of the laser beam is to waste the energy. Also, it may extinguish the plasma, which has been generated with a considerable care. In order to save energy, and stably maintaining the lighting condition, therefore, it is preferred that the pulsing portion of the laser beam P-LB would be halted.

In the example shown in FIG. 3A to FIG. 3D, the controller 30 starts the operation of the laser oscillator 12 such that the high temperature plasma is generated by the pulsed light from the second pumping unit 21b, and the high temperature plasma state is maintained by the continuous laser beam C-LB, which is derived from the continuous light emitted from the first pumping unit 21a. After the time T1 elapses, which is a predetermined time needed for the plasma vessel 11 to stably emit the light, the controller 30 causes the second electricity feeding unit 31b to stop feeding the pulsed electric current such that the second pumping unit 21b stops emitting the pulsed light (pulsing portion of the light).

One exemplary way of carrying out the above-described control will be described. Specifically, the controller 30 (FIG. 1) counts the pulsed electric current, which is supplied from the second electricity feeding unit 31b. After the second pumping unit 21b emits the pulsed light a predetermined number, which is necessary to maintain the high temperature plasma state in the plasma vessel 11 and stably emit the light from the plasma vessel 11, the controller 30 stops the emission of the pulsed light from the second pumping unit 21b (i.e., the controller 30 causes the second pumping unit 21b to stop emitting the pulsed light).

More specifically, the controller 30 has a counter circuit, and the counter circuit counts the number of the pulses, which are supplied from the second electricity feeding unit 31b. When the number of the pulses reaches a predetermined value, then the controller 30 causes the second pumping unit 21b to stop emitting the pulsed light.

Alternatively, the above-described control may be carried out with a timer circuit. As indicated by the broken line in FIG. 1, the laser-driven light source device 10 may include a timer circuit 32, and the controller 30 may activate the timer circuit 32 when the controller 30 starts the operation of the laser oscillator 12. When the time, which is counted by the timer circuit 32, reaches T1, the controller 30 may cause the second electricity feeding unit 31b to stop feeding the pulsed electric current.

Alternatively, the above-described control may be carried out with an optical sensor that detects the excitation light EL emitted from the plasma vessel 11 and confirms the lighting condition. As indicated by the broken line in FIG. 1, the optical sensor 33 may be disposed outside the plasma vessel 11 such that the optical sensor 33 detects the excitation light EL from the plasma vessel 11 and confirms the lighting condition of the plasma vessel 11. Upon confirming the stable lighting condition of the plasma vessel 11, the controller 30 may cause the second electricity feeding unit 31b to stop feeding the pulsed electric current.

Alternatively, after the high temperature plasma state is maintained and the emission of the excitation light becomes stable, the controller 30 may reduce the intensity of the continuous laser beam, as indicated in FIG. 3A, FIG. 3C and FIG. 3D, i.e., the low-intensity continuous laser beam C-LB may be used, as long as the high temperature plasma state is maintained.

In short, the controller 30 may utilize the counter circuit, the timer circuit, the optical sensor or the like to reduce the continuous electric current to be supplied from the first electricity feeding unit 31a after the time T2 elapses. When the time T2, which is a predetermined time that can maintain the stable lighting of the plasma vessel even if the intensity of the continuous laser beam drops, elapses from the start of the operation of the laser oscillator 12, the controller 30 may reduce the continuous electric current to be supplied from the first electricity feeding unit 31a, and reduce the intensity of the continuous light emitted from the first pumping unit 21a.

This may result in the drop of the density of the high temperature plasma, as shown in FIG. 3D, but the generation of the excitation light is maintained.

In this manner, those parts of the laser oscillator 12 which include the second electricity feeding unit 31b for supplying the pulsed electric current and the second pumping unit 21b for irradiating the laser medium 23 with the pulsed light, as illustrated in FIG. 2, serve in combination as a “light up” (or firing) source X for generating the high temperature plasma in the plasma vessel 11.

Similarly, another parts of the laser oscillator 12 which include the first electricity feeding unit 31a for supplying the continuous electric current and the first pumping unit 21a for irradiating the laser medium 23 with the continuous light serve in combination as a “light maintaining” source Y for maintaining the high temperature plasma in the plasma vessel 11.

In this specification, the “light up” means that the laser oscillator 12 starts operating, and the creating or establishing of the high temperature plasma state starts. The “light maintaining” means that the plasma vessel 11 continuously emits the excitation light.

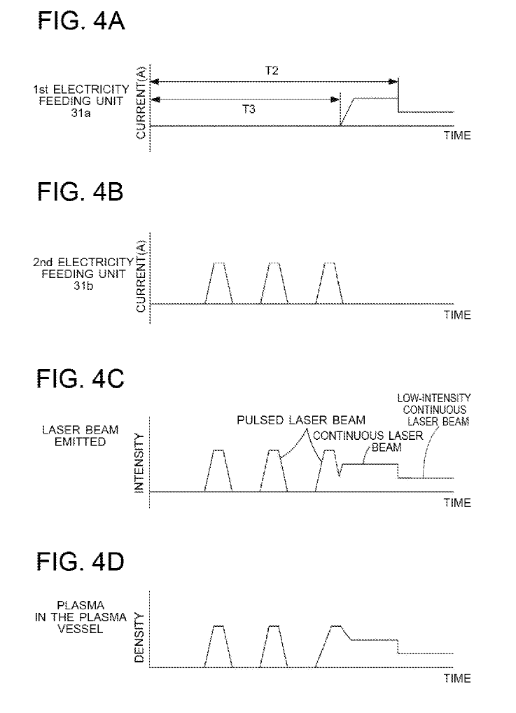

FIG. 4A to FIG. 4D are timing charts to show another example of the operations of the laser-driven light source device 10 and the laser oscillator 12. In the example shown in the timing charts of FIG. 4A to FIG. 4D, the continuous laser beam C-LB is emitted when a predetermined time passes after the laser oscillator 12 starts operating to emit the pulsed laser beam P-LB.

As shown in FIG. 4B, the controller 30 controls the second electricity feeding unit 31b such that the second electricity feeding unit 31b supplies the pulsed electric current to the second pumping unit 21b. Thus, the second pumping unit 21b supplies the pulsed light to the laser medium 23, i.e., the laser medium 23 is irradiated with the pulsed light.

As the laser medium 23 is excited by the pulsed light from the second pumping unit 21b and the resonation takes place in the resonator 24, the laser medium 23 emits the laser beam that exits from the first reflection mirror 24a (unshaded arrow in FIG. 1).

The intensity of the laser beam emitted from the first reflection mirror 24a is shown in FIG. 4C. Specifically, the pulsed laser beam P-LB is emitted from the first reflection mirror 24a.

The laser beam B emitted from the laser oscillator 12 is converged by the converging component 14 (FIG. 1), and makes a focal point in the plasma vessel 11. Thus, the light emitting chemical elements in the plasma vessel 11 are excited, and the high temperature plasma state is established as shown in FIG. 4D. The excitation light is generated from the light emitting chemical elements in the high temperature plasma state.

After the high temperature plasma state is established in the plasma vessel 11, the controller 30 controls the first electricity feeding unit 31a, as shown in FIG. 4A, such that the first electricity feeding unit 31a supplies the continuous electric current to the first pumping unit 21a. Thus, the first pumping unit 21a supplies the continuous light to the laser medium 23.

One exemplary way of this control may use the timer circuit, as in the case described in connection with FIG. 3A to FIG. 3D.

Specifically, the controller 30 causes the timer circuit 34 (FIG. 1) to count the time, and causes the first electricity feeding unit 31a to supply the continuous current to the first pumping unit 21a as the time T3 elapses. The time T3 is a time necessary for the high temperature plasma state to enter the maintaining condition (stable state), after the operation of the laser oscillator 12 starts and the high temperature plasma state is established in the plasma vessel 11 by the pulsed laser beam P-LB emitted from the laser oscillator 12.

After the continuous electric current is supplied, the controller 30 causes the second electricity feeding unit 31b to stop supplying the pulsed electric current to the second pumping unit 21b. Thus, the second pumping unit 21b stops irradiating the laser medium 23 with the pulsed light.

The laser medium 23 is excited by the continuous light emitted from the first pumping unit 21a, and the resonation takes place in the resonator 24 of the laser oscillator 12 such that the laser oscillator 12 emits the continuous laser beam C-LB, as shown in FIG. 4D.

As described above, the continuous laser beam C-LB emitted from the laser oscillator 12 maintains the high temperature plasma state in the plasma vessel 11. Thus, the excitation light is emitted from the plasma vessel 11.

In this example, firstly, the plasma vessel 11 is irradiated with the pulsed laser beam P-LB to form the high temperature plasma state in the plasma vessel 11. After the high temperature plasma state is formed, the plasma vessel 11 is irradiated with the continuous laser beam C-LB. Therefore, it is possible to maintain the high temperature plasma state, which is formed by the pulsed laser beam P-LB, by the continuous laser beam C-LB.

As described above, the pulsed laser beam P-LB is not necessary after the high temperature plasma state is formed. Thus, the controller 30 causes the second electricity feeding unit 31b to stop supplying the pulsed electric current to the second pumping unit 21b after the high temperature plasma state is formed. As such, the controller 30 causes the second pumping unit 21b to stop emitting the pulsed light after the high temperature plasma state is formed.

When the control using the timing charts shown in FIG. 4A to FIG. 4D is employed, the timer circuit may be replaced with a counter, as in the case described in connection with FIG. 3A to FIG. 3D.

Specifically, the controller 30 may have a counter (or connected to a counter) to count the number of the pulsed electric current, which is supplied from the second electricity feeding unit 31b. When the number of the pulsed light from the second pumping unit 21b reaches a predetermined value that is necessary for the plasma vessel 12 to stably emit light, then the controller 30 causes the first electricity feeding unit 31a to supply the continuous electric current to the first pumping unit 21a such that the first pumping unit 21a emits the continuous light. Thus, the high temperature plasma state in the plasma vessel 11 is maintained and stably emits the light.

After that, the controller 30 may cause the second pumping unit 21b to stop emitting the pulsed light.

Also, the control using the timing charts shown in FIG. 4A to FIG. 4D may utilize the optical sensor 32 disposed outside the plasma vessel 11, as in the case described in connection with FIG. 3A to FIG. 3D. The optical sensor 32 detects the excitation light EL emitted from the plasma vessel 11 and confirms the lighting state, i.e., confirms that the light is stably and continuously emitted. Upon confirming the fact of the stable lighting of the plasma vessel 11, the controller 30 may cause the first electricity feeding unit 31a to supply the continuous electric current to the first pumping unit 21a, and cause the second electricity feeding unit 31b to stop supplying the pulsed electric current to the second pumping unit 21b.

After the high temperature plasma state is maintained and the emission of the excitation light becomes stable, the controller 30 may reduce the intensity of the continuous laser beam C-LB and may only use the low-intensity continuous laser beam C-LB, as shown in FIG. 4A, FIG. 4C and FIG. 4D, to the extent that the high temperature plasma state is maintained, as in the case described in connection with FIG. 3A to FIG. 3D. Specifically, the controller 30 may reduce the electric current to be supplied from the first electricity feeding unit 31a after the time T2 elapses. The time T2 is a predetermined time that can maintain the stable lighting of the plasma vessel even if the intensity of the continuous laser beam C-LB drops after the start of the operation of the laser oscillator 12. The controller 30 may, therefore, reduce the intensity of the light emitted from the first pumping unit 21a. As a result, the density of the high temperature plasma drops, as shown in FIG. 4D, but the emission of the excitation light is maintained.

Examples of the numerical values and materials that may be used in the embodiment of FIG. 1, FIG. 2 and FIG. 3A to FIG. 3D are shown below.

Shape of the plasma vessel: Bulb

Material of the plasma vessel: Quartz glass

Outer diameter of the plasma vessel: 30 mm

Inner diameter of the plasma vessel: 26 mm

Light emitting chemical elements in the plasma vessel: Xenon

Xenon gas pressure in the plasma vessel: 10 atmospheric pressure

Laser crystal of the laser oscillator: YAG crystal

Pumping unit: Lamp (e.g., xenon lamp)

Electricity from the 1st electricity feeding unit: Several ampere (A) to several tens ampere

Electricity from the 2nd electricity feeding unit: Several hundred ampere to several kilo ampere (kA), 0.01-10 kHz

Output of the laser beam from the continuous wave laser oscillator: Several tens watt (W) to several hundred watt

Wavelength of the laser beam emitted from the laser oscillator: 1064 nm

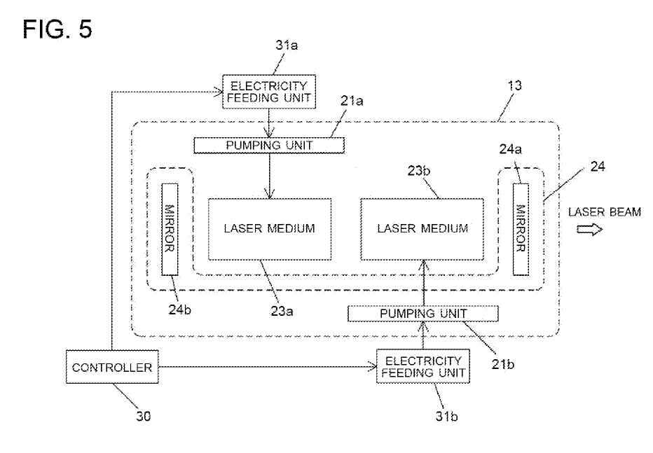

The laser oscillator 12 of the above-described laser-driven light source device 10 has the sole laser medium 23. It should be noted, however, that a plurality of laser media may be provided in the laser oscillator 12, as illustrated in FIG. 5.

The laser oscillator 13 of FIG. 5 is different from the laser oscillator 12 of FIG. 2 in that the laser oscillator 13 has two laser media 23a and 23b and the two pumping units 21a and 21b supply the light to the two laser media 23a and 23b, respectively.

The two laser media, i.e., the first laser medium 23a and the second laser medium 23b, are arranged in series on the optical path in the resonator 24 such that the center axis of the first laser medium 23a aligns with the center axis of the second laser medium 23b. The laser media 23a and 23b may be made from the same material as long as the laser media do not absorb the laser beam emitted from the laser media. Alternatively, the laser media 23a and 23b may be made from different materials as long as the laser media do not absorb the laser beam emitted from the laser media.

The first pumping unit 21a is disposed to face the first laser medium 23a, and supplies (emits) the continuous light to the first laser medium 23a. The second pumping unit 21b is disposed to face the second laser medium 23b, and supplies (emits) the pulsed light to the second laser medium 23b.

The first pumping unit 21a is connected to the first electricity feeding unit 31a, and the second pumping unit 21b is connected to the second electricity feeding unit 31b.

The electricity to be fed to the first pumping unit 21a from the first electricity feeding unit 31a and the electricity to be fed to the second pumping unit 21b from the second electricity feeding unit 31b are controlled by the controller 30 that is connected to the first and second electricity feeding units 31a and 31b.

Other configurations in FIG. 5 are similar to those shown in FIG. 2. The same reference numerals are used to denote the same or similar components in FIG. 2 and FIG. 5.

### Second Embodiment

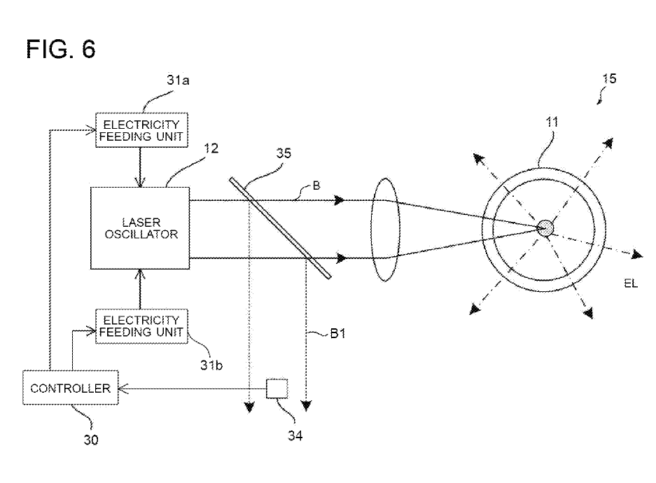

Referring to FIG. 6, a laser-driven light source device 15 according to a second embodiment of the present invention will be described. The laser-driven light source device 15 of the second embodiment includes a mechanism for adjusting the intensity of the laser beam emitted from the laser oscillator to a desired value. The same reference numerals are used to denote the similar components in FIG. 1 and FIG. 6, and redundant explanation of similar components will be omitted in the following description.

A partially transmissive mirror 35 is disposed on the optical path of the laser beam B, which extends to the plasma vessel 11 from the laser oscillator 12. The mirror 35 inclines 45 degrees relative to an optical axis. Part B1 of the laser beam, which is reflected by the partially transmissive mirror 35, proceeds along another optical path on which a laser beam monitor 34 is disposed.

The laser beam B emitted from the laser oscillator 12 passes through the partially transmissive mirror 35, which is located on the optical path of the laser beam B, and proceeds toward the plasma vessel 11, and part B1 of the laser beam B is reflected by the partially transmissive mirror 35. The reflected part B1 of the laser beam B changes its direction 90 degrees and proceeds, as indicated by the broken lines in FIG. 6. The laser beam monitor 34 receives the laser beam B1 and detects its density. The laser beam monitor 34 then sends a signal, which indicates the intensity of the laser beam B1, to the controller 30.

Upon receiving the signal, which indicates an amount of the light received at the laser beam monitor 34, from the laser beam monitor 34, the controller 30 determines whether or not the light has a desired intensity. If the intensity of the light is insufficient, the controller 30 controls the first electricity feeding unit 31a and/or the second electricity feeding unit 31b such that the first electricity feeding unit 31a and/or the second electricity feeding unit 31b supplies an increased amount of the electric current. On the other hand, if the intensity of the light is too strong, the controller 30 controls the first electricity feeding unit 31a and/or the second electricity feeding unit 31b such that the first electricity feeding unit 31a and/or the second electricity feeding unit 31b supplies a reduced amount of the electric current.

Accordingly, the interior of the plasma vessel 11 can obtain (receive) the laser beam having a desired intensity, which is sufficient to form (establish) the high temperature plasma state and/or to maintain the high temperature plasma state.

It should be noted that although the output signal from the laser beam monitor 34 is used to obtain a laser beam having a desired intensity in the above-described embodiment, the controller 30 may monitor and display the intensity of the laser beam emitted from the laser oscillator 12. The controller 30 may also be able to issue a warning signal when the intensity of the laser beam is not in a predetermined range.

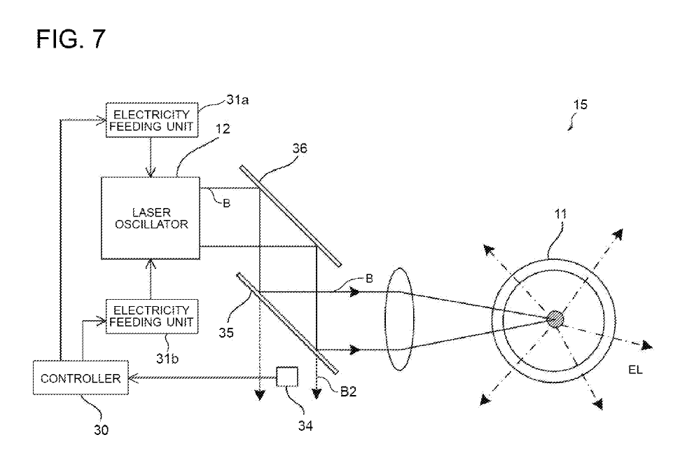

In the second embodiment, the partial transmission mirror 35 is used to extract part B1 of the laser beam emitted from the laser oscillator 12, and the part B1 of the laser beam which is reflected by the partial transmission mirror 35 is monitored. It should be noted, however, that the other part of the laser beam B which passes through the partial transmission mirror 35 may be monitored. An exemplary configuration of such modification will be described with reference to FIG. 7.

Referring to FIG. 7, a total reflection mirror 36 is disposed on the optical path of the laser beam B emitted from the laser oscillator 12, and the laser beam B is totally reflected by the mirror 36 such that the reflected laser beam B proceeds along the altered optical path. The partial transmission mirror (partial reflection mirror) 35 is disposed on the altered optical path, and the laser beam monitor 34 is disposed behind the partial transmission mirror 35. In other words, the laser beam monitor 34 is disposed on an optical path of the laser beam B2 that passes through the partial transmission mirror 35.

In this configuration, the laser beam B emitted from the laser oscillator 12 is totally reflected by the total reflection mirror 36, partially reflected by the partial transmission mirror 35, and proceeds toward the plasma vessel 11.

On the other hand, the laser beam B2 that passes through the partial transmission mirror 35 enters the laser beam monitor 34. As the laser beam monitor 34 receives the laser beam B2, the laser beam monitor 34 produces and sends a signal, which represents the intensity of the laser beam B2, to the controller 30 in a similar manner to the embodiment shown in FIG. 6.

In the embodiment shown in FIG. 6 and its modification shown in FIG. 7, the partially transmissive mirror 35 is located on the initial optical path of the laser beam B emitted from the laser oscillator 12, part B1 or B2 of the laser beam is taken out from the initial optical path by the partially transmissive mirror 35, and the laser beam B1 or B2 which is taken out from the initial optical path is received by the laser beam monitor 34. Then, the laser beam monitor 34 detects the intensity of the laser beam B1 or B2, and sends a signal that indicates the intensity of the laser beam to the controller 30.

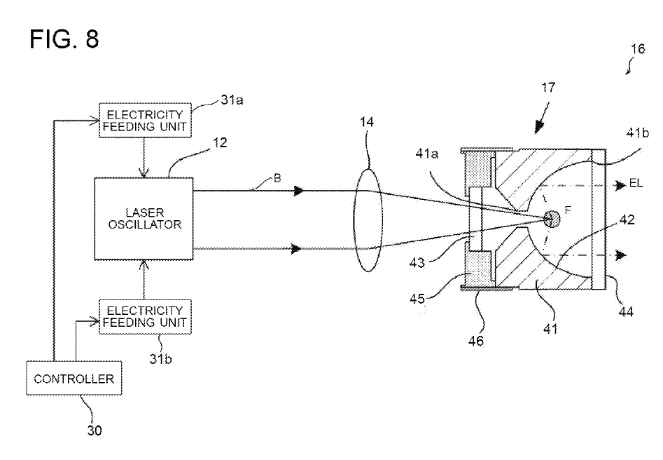

It should be noted that although the plasma vessel 11 has a bulb shape in the foregoing embodiments, the present invention is not limited in this regard and the plasma vessel 11 may have different shapes. Examples of the plasma vessel 11 having different shapes will be described below with reference to FIG. 8 to FIG. 11.

### Third Embodiment

Referring to FIG. 8, a laser-driven light source device 16 according to a third embodiment of the present invention will be described. The same reference numerals are used to denote the similar components in FIG. 1 and FIG. 8, and redundant explanation of similar components will be omitted in the following description. The laser-driven light source device 16 has a plasma vessel 17. The plasma vessel 17 has a main body 41. The main body 41 has a round column shape. In the main body 41, a reflection surface 42 is formed, and the reflection surface 42 is a concave surface. The concave reflection surface 42 may have an oval shape, a parabolic shape or any other suitable shape.

The main body 41 has a rear opening 41a and a front opening 41b. A light entrance window 43 is disposed in the vicinity of (in front of) the rear opening 41a, and a light exit window 44 is disposed at (after) the front opening 41b.

The light entrance window 43 in front of the rear opening 41a of the main body 41 is supported by a window frame member 45. The window frame member 45 is made from metal, and connected to the main body 41 of the plasma vessel 17 by a cylindrical element 46, which is also made from metal. The main body 41, the light entrance window 43 and the light exit window 44 define in combination a closed space and form the plasma vessel 17. The light emitting chemical element(s) is placed in this closed space. The closed space is hermetically sealed.

The laser beam B emitted from the laser oscillator 12 is converged by the converging component 14, and incident to the light receiving window 43 at the rear face of the plasma vessel 17. Then, the laser beam B converges at a focal point F of the concave reflection surface 42. Thus, the plasma is generated, with its center being at the focal point F, and the light emitting chemical element(s) is excited to generate the excitation light EL. The excitation light EL is reflected by the concave reflection surface 42, and exits the plasma vessel 17 from the light exit window 44 at the front face of the plasma vessel 17.

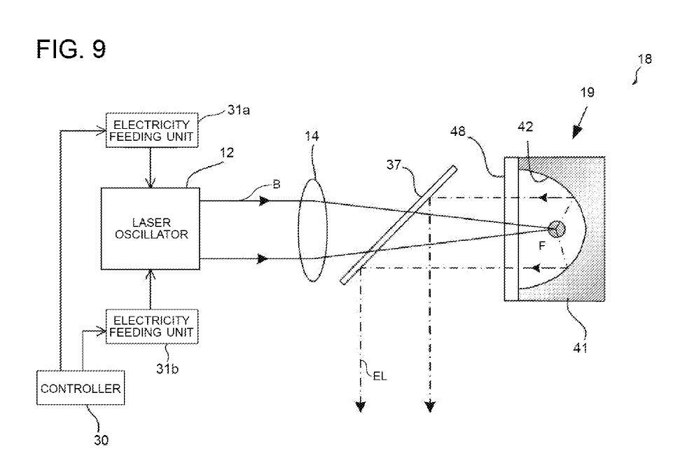

In the laser-driven light source device 16 of the third embodiment shown in FIG. 8, the laser beam enters the plasma vessel 17 from the back side of the concave reflection mirror 42 of the main body 41 of the plasma vessel 17. It should be noted that the present invention is not limited in this regard. For example, the laser beam may enter from the front side of the concave reflection mirror of the main body of the plasma vessel, as shown in FIG. 9 to FIG. 11.

### Fourth Embodiment

Referring to FIG. 9, a laser-driven light source device 18 according to a fourth embodiment of the present invention will be described. The same reference numerals are used to denote the similar components in FIG. 8 and FIG. 9, and redundant explanation of similar components will be omitted in the following description. In the fourth embodiment, the laser-driven light source device 18 has a plasma vessel 19. The plasma vessel 19 has a main body 41, and a front window 48. The main body 41 has a concave reflection surface 42, and a front opening. The front window 48 is disposed at the front opening of the main body 41. The space between the front window 48 and the concave reflection surface 42 is a hermetically closed space. The front window 48 of the plasma vessel 19 faces the laser oscillator 12. The front window 48 serves as the laser beam entrance window and also serves as the excitation light exit window.

Between the laser oscillator 12 and the plasma vessel 19, disposed is a dichroic mirror 37. Specifically, the dichroic mirror 37 is disposed between the light converging component 14 and the plasma vessel 19. The dichroic mirror 37 transmits the laser beam B and reflects the excitation light EL emitted from the plasma vessel 19.

In the laser-driven light source device 18, the laser beam B from the laser oscillator 12 passes through the dichroic mirror 37 and enters the plasma vessel 19 through the front window 48 of the plasma vessel 19. The laser beam B then converges at the focal point F of the concave reflection surface 42. Thus, the plasma is generated at the focal point F, and the excitation light EL is generated. The excitation light EL is reflected by the concave reflection surface 42, and exits the plasma vessel 19 from the front window 48. The concave reflection surface 42 may have a parabolic shape. If the concave reflection surface 42 has the parabolic shape, the excitation light EL exiting from the plasma vessel 19 is parallel light.

The excitation light EL emitted from the plasma vessel 19 is reflected by the dichroic mirror 37 and changes its optical path. Accordingly, the excitation light EL is ultimately emitted to the outside from the light source device 18.

### Fifth Embodiment

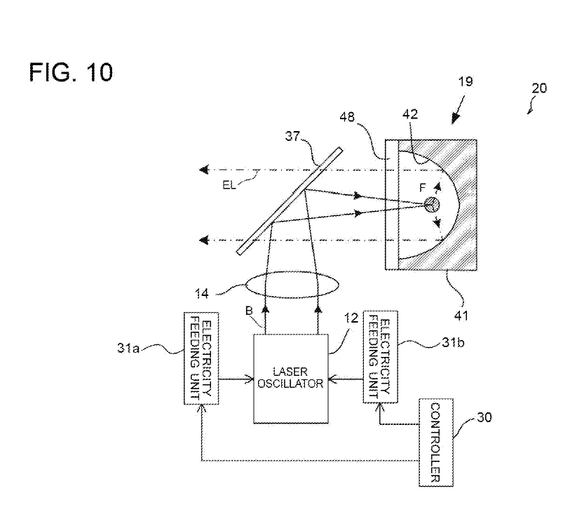

Referring to FIG. 10, a laser-driven light source device 20 according to a fifth embodiment of the present invention will be described. The same reference numerals are used to denote the similar components in FIG. 8 and FIG. 10, and redundant explanation of similar components will be omitted in the following description. In the fifth embodiment, the laser-driven light source device 20 has the plasma vessel 19 at a different position, when compared to the fourth embodiment. The optical path of the laser beam B emitted from the laser oscillator 12 bends 90 degrees before the laser beam B reaches the plasma vessel 19. The laser oscillator 12 and the plasma vessel 19 are not arranged on the same straight line. The center line of the laser oscillator 12 crosses the center line of the plasma vessel 19 at 90 degrees.

The dichroic mirror 37 is disposed between the laser oscillator 12 and the plasma vessel 19. The dichroic mirror 37 reflects the laser beam B and transmits the excitation light EL emitted from the plasma vessel 19.

In the laser-driven light source device 20 of this embodiment, the laser beam B emitted from the laser oscillator 12 is reflected by the dichroic mirror 37 and enters the plasma vessel 19. Then, the laser beam converges at the focal point F of the concave reflection surface 42. The excitation light EL, which is generated from the laser beam B, is reflected by the concave reflection surface 42 and exits from the plasma vessel 19. Then, the excitation light EL passes through the dichroic mirror 37.

### Sixth Embodiment

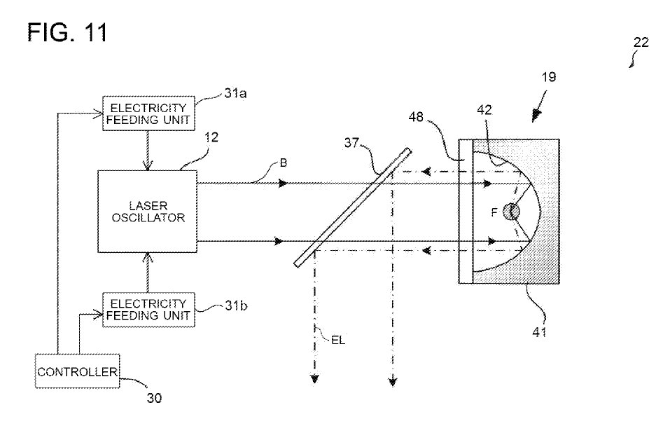

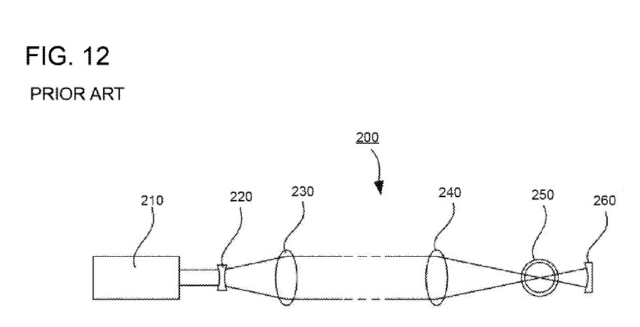

Referring to FIG. 11, a laser-driven light source device 22 according to a sixth embodiment of the present invention will be described. The same reference numerals are used to denote the similar components in FIG. 8 and FIG. 11, and redundant explanation of similar components will be omitted in the following description. In this embodiment, the laser beam B is not converged. The laser beam B is parallel light, and enters the plasma vessel 19. The dichroic mirror 37 is disposed between the laser oscillator 12 and the plasma vessel 19. Similar to the fourth embodiment (FIG. 9), the dichroic mirror 37 transmits the laser beam B and reflects the excitation light EL emitted from the plasma vessel 19.

The laser beam B from the laser oscillator 12 is parallel light. The laser beam B from the laser oscillator 12 passes through the dichroic mirror 37 and enters the plasma vessel 19. Then, the laser beam B is reflected by the concave reflection plane 42 and converges at its focal point F. The excitation light EL, which is generated by the plasma produced in the plasma vessel 19, exits the plasma vessel 19 in the form of parallel light, and is reflected by the dichroic mirror 37 such that the excitation light EL proceeds to the outside. In this embodiment, the concave reflection plane 42 has a parabolic shape.

As described above, each of the laser-driven light source devices 10, 15, 16, 18, 20 and 22 of the above-described embodiments forms a high temperature plasma state with the pulsed laser beam P-LB when the lighting starts. Also, the laser-driven light source device 10, 15, 16, 18, 20, 22 uses the continuous laser beam C-LB to prevent the high temperature plasma state from discontinuing or reduce the possibility of such discontinuity of the high temperature plasma state, thereby maintaining the high temperature plasma state once the high temperature plasma state is created.

Unlike the pulsed laser beam P-LB, the continuous laser beam C-LB is not a high-intensity laser beam. Thus, an amount of energy introduced into the plasma vessel 11, 17, 19 is not large. Accordingly, it is possible to prevent the plasma vessel 11, 17, 19 from being heated excessively, i.e., it is possible to prevent the plasma vessel 11, 17, 19 from deforming and/or being distorted, due to heating. This can extend the life of the lighting of the light source device 10, 15, 16, 18, 20, 22.

In each of the laser-driven light source devices 10, 15, 16, 18, 20 and 22 of the above-described embodiments, the second electricity feeding unit 31b feeds the pulsed electric current after the first electricity feeding unit 31a feeds the continuous electric current. Thus, the laser beam emitted from the laser oscillator 12, 13 contains the pulsed laser beam part P-LB in addition to the continuous laser beam part C-LB.

In the plasma vessel 11, 17, 19, therefore, it is possible to create the high temperature plasma state with the pulsed laser beam part P-LB and appropriately maintain the high temperature plasma state with the continuous laser beam part C-LB.

The second electricity feeding unit 31b may feed the pulsed electric current to form the pulsed laser beam P-LB. Thus, the pulsed laser beam P-LB may create the high temperature plasma state in the plasma vessel 11, 17, 19 and then the continuous laser beam C-LB may be supplied.

In this case, the pulsed laser beam P-LB can form the high temperature plasma state, and the continuous laser beam C-LB can appropriately maintain the high temperature plasma state.

In the laser-driven light source device 10, 15, 16, 18, 20, 22 of this embodiment, the single laser oscillator 12, 13 may serve as the light up source (firing source) and the light maintaining source. Thus, it is not necessary to prepare two separate laser oscillators, namely, a laser oscillator for firing, and another laser oscillator for maintain the lighting. Therefore, it is possible to prevent the light source device from having an unnecessarily large size.

Because the plasma vessel 17 (19) includes the main body 41, which has the concave reflection surface 42, and the window member 45 (48), the material of the plasma vessel is not limited to silica glass. For example, the main body 41 may be made from a ceramics material, or a metallic material such as aluminum. The window member may be made from a crystal material such as sapphire or rock crystal. By using such materials for the plasma vessel, the plasma vessel does not have distortions and deformations due to the ultraviolet light, even if the plasma vessel is irradiated with the high-intensity ultraviolet light and vacuum ultraviolet light, which is derived from the plasma.

It should be noted that the laser-driven light source device of the present invention may be used as a light source device for an exposure device. If the light emitting chemical elements in the plasma vessel are altered, it is possible to change the wavelength of the light beam emitted from the plasma vessel. For example, the laser-driven light source device of the present invention may emit a visible light beam, and the laser-driven light source device may be used as a light source device for a motion picture projector.

A lamp that includes a plasma vessel, and a pair of electrodes facing each other in the plasma vessel is known in the art, and used as a light source in various applications. The laser-driven light source device of the present invention may be used in place of such conventional lamp in the same applications as the conventional lamp.

While certain embodiments have been described, these embodiments have been presented by way of example only, and are not intended to limit the scope of the present invention. The novel apparatuses (devices) and methods thereof described herein may be embodied in a variety of other forms; furthermore, various omissions, substitutions and changes in the form of the apparatuses (devices) and methods thereof described herein may be made without departing from the gist of the present invention. The appended claims and their equivalents are intended to cover such forms or modifications as would fall within the scope and gist of the present invention.

This application is based upon and claims the benefit of a priority from Japanese Patent Application No. 2016-124148, filed Jun. 23, 2016, and the entire contents of which are incorporated herein by reference.

What is claimed is:

1. A laser-driven light source device comprising:
a laser oscillator configured to emit a continuous laser beam and a pulsed laser beam, the laser oscillator having:
a resonator in which a pair of reflection mirrors are disposed,
at least one laser medium placed in the resonator,
a first pumping unit configured to supply light to the at least one laser medium, and
a second pumping unit configured to supply another light to the at least one laser medium,
a plasma vessel configured to receive the continuous laser beam and the pulsed laser beam from the laser oscillator, generate plasma, and emit light derived from the plasma;
a first electricity feeding unit configured to feed electricity to the first pumping unit;
a second electricity feeding unit configured to feed electricity to the second pumping unit; and
a controller configured to control the first electricity feeding unit such that the first pumping unit generates continuous light, and control the second electricity feeding unit such that the second pumping unit generates pulsed light.

2. The laser-driven light source device according to claim 1, wherein the controller controls the first and second electricity feeding units such that the pulsed laser beam generates the plasma in the plasma vessel, the continuous laser beam stabilizes and maintains the plasma, and then the pulsed laser beam is halted.

3. The laser-driven light source device according to claim 1, wherein the at least one laser medium is a single laser medium, and the first and second pumping units face the single laser medium.

4. The laser-driven light source device according to claim 2, wherein the at least one laser medium is a single laser medium, and the first and second pumping units face the single laser medium.

5. The laser-driven light source device according to claim 1, wherein the at least one laser medium includes a first laser medium and a second laser medium, the first and second laser media are arranged in series such that a center axis of the first laser medium aligns with a center axis of the second laser medium, the first pumping unit faces the first laser medium, and the second pumping unit faces the second laser medium.

6. The laser-driven light source device according to claim 2, wherein the at least one laser medium includes a first laser medium and a second laser medium, the first and second laser media are arranged in series such that a center axis of the first laser medium aligns with a center axis of the second laser medium, the first pumping unit faces the first laser medium, and the second pumping unit faces the second laser medium.

7. The laser-driven light source device according to claim 1 further comprising:
a partially transmissive mirror placed on an optical path between the laser oscillator and the plasma vessel, and configured to extract part of the pulsed laser beam and the continuous laser beam emitted from the laser oscillator, out of the optical path; and
a laser beam monitor configured to receive the extracted laser beam.

8. The laser-driven light source device according to claim 2 further comprising:
a partially transmissive mirror placed on an optical path between the laser oscillator and the plasma vessel, and configured to extract part of the pulsed laser beam and the continuous laser beam emitted from the laser oscillator, out of the optical path; and
a laser beam monitor configured to receive the extracted laser beam.

9. The laser-driven light source device according to claim 3 further comprising:
a partially transmissive mirror placed on an optical path between the laser oscillator and the plasma vessel, and configured to extract part of the pulsed laser beam and the continuous laser beam emitted from the laser oscillator, out of the optical path; and
a laser beam monitor configured to receive the extracted laser beam.

10. The laser-driven light source device according to claim 5 further comprising:
a partially transmissive mirror placed on an optical path between the laser oscillator and the plasma vessel, and configured to extract part of the pulsed laser beam and the continuous laser beam emitted from the laser oscillator, out of the optical path; and
a laser beam monitor configured to receive the extracted laser beam.

11. The laser-driven light source device according to claim 1 further comprising an optical sensor disposed outside the plasma vessel and configured to receive excitation light emitted from the plasma vessel, wherein the controller determines whether the plasma is stable and maintained in the plasma vessel based on the excitation light received at the optical sensor, and controls the second electricity feeding unit such that the pulsed laser is halted when the controller confirms that the plasma is in a stable condition.

12. The laser-driven light source device according to claim 2 further comprising an optical sensor disposed outside the plasma vessel and configured to receive excitation light emitted from the plasma vessel, wherein the controller determines whether the plasma is stable and maintained in the plasma vessel based on the excitation light received at the optical sensor, and controls the second electricity feeding unit such that the pulsed laser is halted when the controller confirms that the plasma is in a stable condition.

13. The laser-driven light source device according to claim 3 further comprising an optical sensor disposed outside the plasma vessel and configured to receive excitation light emitted from the plasma vessel, wherein the controller determines whether the plasma is stable and maintained in the plasma vessel based on the excitation light received at the optical sensor, and controls the second electricity feeding unit such that the pulsed laser is halted when the controller confirms that the plasma is in a stable condition.

14. The laser-driven light source device according to claim 5 further comprising an optical sensor disposed outside the plasma vessel and configured to receive excitation light emitted from the plasma vessel, wherein the controller determines whether the plasma is stable and maintained in the plasma vessel based on the excitation light received at the optical sensor, and controls the second electricity feeding unit such that the pulsed laser is halted when the controller confirms that the plasma is in a stable condition.

15. The laser-driven light source device according to claim 7 further comprising an optical sensor disposed outside the plasma vessel and configured to receive excitation light emitted from the plasma vessel, wherein the controller determines whether the plasma is stable and maintained in the plasma vessel based on the excitation light received at the optical sensor, and controls the second electricity feeding unit such that the pulsed laser is halted when the controller confirms that the plasma is in a stable condition.

16. The laser-driven light source device according to claim 1 further comprising a light converging element disposed on an optical path between the laser oscillator and the plasma vessel to converge the continuous laser beam and the pulsed laser beam to a focal point in the plasma vessel, the light converging element being made from a material that transmits the laser beam and excitation light generated from the plasma vessel.

17. The laser-driven light source device according to claim 1, wherein each of the first and second pumping units includes at least one laser diode.

18. The laser-driven light source device according to claim 1, wherein the controller controls the first and second electricity feeding units such that a combination of the continuous laser beam and the pulsed laser beam generates the plasma in the plasma vessel, and the continuous laser beam stabilizes and maintains the plasma.

19. The laser-driven light source device according to claim 1, wherein the controller controls the first electricity feeding unit such that the first electricity feeding unit feeds less electricity to the first pumping unit in order to reduce intensity of the continuous light emitted from the first pumping unit after the plasma becomes stable.
